(19) United States
(12) Patent Application Publication
(10) Pub. No.: US 2026/0192249 A1
(43) Pub. Date: Jul. 9, 2026

(54) MULTIMETALLIC OXIDES FOR THERMALLY REVERSIBLE NOX SORPTION

(71) Applicant: THE JOHNS HOPKINS UNIVERSITY, Baltimore, MD (US)

(72) Inventors: Chao Wang, Ellicott City, MD (US); Peikun Wang, Baltimore, MD (US); Zeyuan Sun, Baltimore, MD (US); Pengfei Xie, Baltimore, MD (US); Han Zong, Baltimore, MD (US)

(21) Appl. No.: 19/551,013

(22) Filed: Feb. 26, 2026

Related U.S. Application Data
(63) Continuation of application No. 17/926,935, filed on May 19, 2021, now abandoned.
(60) Provisional application No. 63/027,013, filed on May 19, 2020.

(51) Int. Cl. B01D 53/86; B01D 53/02; B01D 53/14; B01J 23/34; F01N 3/08

(52) U.S. Cl. CPC B01D 53/8628; B01D 53/02; B01D 53/14; B01J 23/34; F01N 3/0842; B01D 2255/2073; B01D 2257/404; B01D 2258/01; F01N 2370/02

(57) ABSTRACT

A Nitrogen Oxide (NOX) sorbent material of the present invention includes a multi-metallic oxide that includes one or more alkali or alkaline earth metal, one or more 3d transition metal, and one or more rare earth element. The NOx sorbent material is configured to adsorb and absorb NOx below a low temperature and to release the adsorbed or absorbed NOx at temperature at or above the low temperature. In some embodiments, a manganese catalyst is deposited on a high surface area carrier. The manganese catalyst takes the form of an alkali/metal promotor and an Mn-based compound. In general, the NOx sorbent material contains about one percent to about fifty percent by weight of alkali/alkaline earth metal manganese catalyst based on the total weight of the catalyst.

### CROSS REFERENCE TO RELATED APPLICATIONS

This application is a Continuation of U.S. patent application Ser. No. 17/926,935 filed on Nov. 21, 2022, which is a 35 U.S.C. § 371 U.S. national entry of International Application PCT/US2021/033202, having an international filing date of May 19, 2021, which claims the benefit of U.S. Provisional Application No. 63/027,013, filed May 19, 2020, the content of each of the aforementioned applications is herein incorporated by reference in their entirety.

### GOVERNMENT RIGHTS

This invention was made with government support under DE-AR0000952 awarded by the Department of Energy. The government has certain rights in the invention.

### FIELD OF THE INVENTION

The present invention relates generally to the reduction of emissions. More particularly the present invention relates to a Nitrogen Oxide (NOx) sorbent material for an exhaust system.

### BACKGROUND OF THE INVENTION

Over the past several decades, NOx emission from industry, automobiles and other sources have been required to satisfy increasingly strict governmental regulation. In order to meet stringent federal regulations, engineers are constantly exploring new strategies for reduction of NOx emissions from different sources.

One method of reducing NOx is the NOx adsorber, which does not require after treatment and extensive support infrastructures. An NOx adsorber has two alternate phases: an adsorption/storage phase and a desorption/regeneration phase. NOx emissions are stored on a catalyst when at a low temperature, released when at a high temperature, and eventually converted to nitrogen and water with the appearance of a conventional three-way catalyst or ammonia selective catalytic reduction.

In previous systems, a cold start NOx adsorber is applied in an exhaust system. The NOx adsorber includes a zeolite catalyst and one or more platinum group metals (PGM) with inorganic oxide carriers. Although using a noble metal/zeolite NOx adsorber catalyst shows high NO storage capacity and conversion, the high cost of noble metal catalysts limits their practical application.

In order to broaden their application, there is a continued need for a PGM-free NOx sorbent material with a lower price and higher storage capacity. It would therefore be advantageous to provide an improved sorbent material for an exhaust system for an internal combustion engine.

### SUMMARY OF THE INVENTION

In accordance with an embodiment, the present invention provides a NOx sorbent material taking the form a multimetallic oxide that involves one or more alkali or alkaline earth metal (Li, Na, K, Rb, Cs, Be, Mg, Ca, Sr, Ba), one or more 3d transition metal (Ti, V, Cr, Mn, Fe, Co, Ni, Cu, Zn) and one or more rare-earth element (La, Ce, Pr, Nd, Pm, Sm, Eu, Gd, Tb, Dy, Ho, Er, Tm, Yb, Lu, etc.). The NOx sorbent material is configured to adsorb and absorb NOx at or below a low temperature and to release the adsorbed and absorbed NOx at temperature above the low temperature.

In accordance with an aspect of the present invention the low temperature is 350° C. The 3d metal takes the form of a promoter. The promoter takes the form of metal compounds selected from 3d transition metals (Ti, V, Cr, Mn, Fe, Co, Ni, Cu, Zn), and can take the form of oxides, hydroxides, carbonates, bicarbonates, nitrates, nitrites of lithium, sodium, potassium, cesium, magnesium, calcium, strontium, barium and mixtures thereof. The supporter material takes the form of a support with a predetermined surface area. The support material is one chosen from a group consisting of inorganic oxides including transition metal oxides (such as TiO₂), main-group metal oxides (such as MgO), rare earth metal oxides (such as CeO₂) and etc., zeolites, large surface area carbon-based materials or a mixture of any two or more thereof, e.g. ceria-zirconia or ceria-zirconia-alumina. Other additives, such as a various amount of precious metals or transition metal oxide additives (vanadium oxides, iron oxides, copper oxides, and so on), are also beneficial to improve the NOx storage capacity of the catalyst. An applicable oxygen concentration range from 0 to 21%.

In accordance with an embodiment, the present invention provides a NOx sorbent material having a manganese catalyst. The material also includes a support material. The NOx sorbent material is configured to adsorb and absorb NOx below a low temperature and to release the adsorbed and absorbed NOx at temperature above the low temperature.

In accordance with an aspect of the present invention the low temperature is 350° C. The manganese catalyst takes the form of a promoter and an Mn-based compound. The promoter is metal compounds selected from Group IA and Group IIA, and can take the form of hydroxides, carbonates, bicarbonates, nitrates, nitrites of lithium, sodium, potassium, cesium, magnesium, calcium, strontium, barium and mixtures thereof. The supporter material takes the form of a support with a predetermined surface area. The support material is one chosen from a group consisting of inorganic oxides including transition metal oxides (such as TiO₂), main-group metal oxides (such as MgO), rare earth metal oxides (such as CeO₂) and etc., zeolites, large surface area carbon-based materials or a mixture of any two or more thereof, e.g. ceria-zirconia or ceria-zirconia-alumina. Other additives, such as a various amount of precious metals or transition metal oxide additives (vanadium oxides, iron oxides, copper oxides, and so on), are also beneficial to improve the NOx storage capacity of the catalyst. An applicable oxygen concentration range from 0 to 21%. The manganese catalyst further comprises 1% to 50% of promoter based on a total weight of the manganese catalyst.

In accordance with another aspect of the present invention, a method of using the NOx sorbent material includes adsorbing and absorbing NOx from exhaust gas generated by low temperature combustion (LTC) diesel or gasoline engine in various operating conditions. A method of using the NOx sorbent material includes operating the NOx sorbent material during a full period following a cold start. A method of using the NOx sorbent material further includes operating the NOx sorbent material during a full period following a cold start through a warmed-up operation. A method of using the NOx sorbent material can also include operating the NOx sorbent material during an operation period of one chosen from a group consisting of a lean-burn gasoline engine, a clean diesel engine combustion engine (CDC), and a gas direct injection engine (GDI).

In accordance with yet another aspect of the present invention, a method of NOx sorption includes applying an NOx sorbent material to exhaust gas, wherein the NOx sorbent material includes a manganese catalyst, and a support material. The NOx sorbent material is configured to adsorb and absorb NOx below a low temperature and to release the adsorbed and absorbed NOx at temperature at or above the low temperature.

In accordance with still another aspect of the present invention, the method further using the NOx sorbent material during a full period following a cold start. The method further includes using the NOx sorbent material during a full period following a cold start through a warmed-up operation. The method of claim 17 further includes using the NOx sorbent material during an operation period of one chosen from a group consisting of a lean-burn gasoline engine, a clean diesel engine combustion engine (CDC), and a gas direct injection engine (GDI).

### DETAILED DESCRIPTION OF THE PREFERRED EMBODIMENTS

The presently disclosed subject matter now will be described more fully hereinafter with reference to the accompanying Drawings, in which some, but not all embodiments of the inventions are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

An NOx sorbent material includes at least one alkali or alkaline earth metal promoter and manganese catalyst which can be used for exhaust after treatment systems for use in almost all types of diesel/gasoline engines in various operating conditions or any other application known to or conceivable to one of skill in the art. In some embodiments the NOx sorbent material can be used for treatment of exhaust from a stationary source. In other embodiments, an NOx sorbent material is designed for use in the after treatment of exhaust emissions from sources such as vehicles, light/heavy duty trucks, buses, or other vehicles with a combustion engine.

A NOx sorbent material according to an embodiment of the present invention provides NOx absorption and absorption from exhaust gas generated by low temperature combustion (LTC) diesel or gasoline engine in various operating conditions. The NOx sorbent material is used in the full period following a cold start through a warmed-up operation. However, in some embodiments of the present invention the NOx sorbent material may also be used during the operation period of lean-burn gasoline engines, clean diesel engine combustion engines (CDCs), gas direct injection engines (GDI) and any other engines known to or conceivable to one of skill in the art.

Generally, the NOx sorbent material includes a multimetallic oxide that involves one or more alkali or alkaline earth metal (Li, Na, K, Rb, Cs, Be, Mg, Ca, Sr, Ba), one or more 3d transition metal (Ti, V, Cr, Mn, Fe, Co, Ni, Cu, Zn) and one or more rare-earth element (La, Ce, Pr, Nd, Pm, Sm, Eu, Gd, Tb, Dy, Ho, Er, Tm, Yb, Lu, etc.). The NOx sorbent material is configured to adsorb and absorb NOx at or below a low temperature and to release the adsorbed and absorbed NOx at temperature above the low temperature. The low temperature can vary based on the materials used, but in most cases the low temperature is at or around 350° C.

In some embodiments, the NOx sorbent material includes a manganese catalyst deposited on a high surface area carrier. The manganate oxide catalyst comprises an alkali/alkaline earth metal promotor and Mn-based compound. In general, the NOx sorbent material contains about one percent to about fifty percent by weight of alkali/alkaline earth metal manganese catalyst based on the total weight of the catalyst.

The NOx sorbent material includes a catalyst to effectively adsorb and absorb emissions during the operation period from 25° C. to 350° C., desorb and regenerate during the operation period from 350° C. to 650° C., with oxygen level between 0 to 21%. The catalyst provides better NOx storage and release than PGMs under these operating conditions.

The catalyst effectively absorbs NOx emission at any temperature below 350° C. and releases adsorbed and absorbed NOx at or above 350° C. The NOx sorbent material of the present invention includes a manganese catalyst and a high surface area carrier. The manganese catalyst has one or more alkali metal promotors and one or more Mn-based compounds.

The alkali and alkaline earth metal promotors take the form of alkali and alkaline earth metals, common metals of Group IA and IIA of the Period Table of Elements. Lithium, sodium, potassium, cesium, magnesium, calcium, strontium, barium or mixtures thereof are particular preferably. The Mn-based compound(s) can include inorganic manganate oxides (such as manganese dioxide), inorganic/organic manganese compounds (such as manganese chloride and manganese acetate), or mixture thereof. Sodium manganate and potassium manganate are particularly preferred.

The manganese catalyst can be synthesized by any methods known to or conceivable by one of skill in the art. For example, an alkali/alkaline earth metal can be added to Mn-based compounds to synthesize the manganese catalyst by any method known to or conceivable by one of skill in the art. An alkali/alkaline earth metal compound (such as sodium nitrate) or other metal compounds can also be added to the manganese catalyst by any method known to or conceivable by one of skill in the art. The manner of addition is not of particular importance. The alkali/alkaline earth metal(s) and/or alkali/alkaline earth metal compound(s) can be added to the Mn-based compound simultaneously in one step or sequentially in two or more steps.

Supported large surface area carriers are preferably inorganic oxides including transition metal oxides (such as TiO₂), main-group metal oxides (such as MgO), rare earth metal oxides (such as CeO₂), or other materials known to or conceivable to one of skill in the art. Zeolite and large surface area carbon-based materials can also be used. A mixture of any two or more of these materials known to or conceivable to one of skill in the art, e.g. ceria-zirconia or ceria-zirconia-alumina, could also be used.

To create the NOx sorbent material, an alkali and/or alkaline earth metal and a Mn-based compound may be supported on a large surface area carrier by impregnation, sol-gel, solution combustion, incipient wetness, coprecipitation, precipitation, adsorption, ion-exchange, chemical deposition, pyridine thermal, hydrolysis, or combination thereof. Any other method known to or conceivable to one of skill in the art can also be used. The alkali/alkaline earth metal compound and the Mn-based compound can be added to the carrier simultaneously in one step or sequentially in two or more steps.

Alternately, compounds other than Mn-based compounds can be used. In such embodiments, the NOx sorbent material can be formed from a multimetallic oxide that involves one or more alkali or alkaline earth metal (Li, Na, K, Rb, Cs, Be, Mg, Ca, Sr, Ba), one or more 3d transition metal (Ti, V, Cr, Mn, Fe, Co, Ni, Cu, Zn) and one or more rare-earth element (La, Ce, Pr, Nd, Pm, Sm, Eu, Gd, Tb, Dy, Ho, Er, Tm, Yb, Lu, etc.)

Other additives, such as a various amount of platinum group metals (Ru, Rh, Pd, Os, Ir and Pt) and some transition metal oxides (vanadium oxide, iron oxides, cobalt oxides, copper oxides, and so on), can be added by any methods known to or conceivable by one of skill in the art and the manner of addition is not of particular importance. Those additives have a certain NO oxidation ability, which can promote the storage speed of NOx as well as NH₃—SCR if there is one to combine with.

The following examples merely illustrate the invention and are not meant to be considered limiting. Those skilled in the art will recognize many variations that are within the spirit of the invention and scope of the claims.

### Example 1: NOx Adsorption and Absorption Catalyst Preparations

MC and MT: A certain amount of Mn (NO₃)₂ was dissolved in deionized water. Then a certain amount of commercial CeO₂ and stoichiometric sodium hydroxide solution were added to the slurry with vigorous stirring. The mixture was aged for 24 hours and then filtered and washed with deionized water three times. The obtained solid samples were first dried at 120° C. in air for 12 h and then calcined at 650° C. for 5 h in air, which was denoted as MC. In a similar way, the other catalyst was synthesized by using the TiO₂ (P25) as a support, which was denoted as MT.

Na-MC: A sodium promoted sample was prepared via the wet-impregnation method. Typically, weight a certain amount of prepared MC catalyst and sodium hydroxide, and then add some deionized water. The mixture was first sonicated for half an hour, then the excess water was removed in a rotary evaporator at 50° C. under vacuum condition until it completely dried. The obtained solid samples were calcined at 650° C. for 5 h in air, which was denoted as Na-MC.

All the obtained solid products were crushed and sieved to 40-60 mesh before the performance test.

### Example 2: NOx Adsorption and Absorption Capacity Testing Procedures

The NOx sorbent material (0.1 g) is put at certain adsorption and absorption temperatures (such as 25° C., 100° C., 200° C. and 300° C.) for 30 min in a NOx-containing gas mixture with a flow rate of 167 ml/min (MHSV=100 L/h/g). This adsorption and absorption stage is followed by the TPD (Temperature-Programmed-Desorption) at a ramping rate of 10° C./min in the presence of the NOx-containing gas until the bed temperature reaches about 600° C. in order to remove all stored NOx on catalyst for further testing.

The NOx-containing gas mixture during both the adsorption/absorption and desorption phases includes 12 vol. % 02, 100 ppm NOX, 2000 ppm CO, 1000 ppm C₃H₆, 670 ppm H₂, 2 vol. % H₂O.

The NOx adsorption and absorption capacity is calculated as the amount of NOx stored per gram of catalysts, the results of different catalyst at different temperature are shown in Table 1.

### Example 3: NOx Adsorption and Absorption Capacity after Sulfur Exposure Testing Procedures

The catalysts (MC and Na-MC) were subjected to a certain level of sulfation by contacting them with SO₂ containing gas (25 ppm SO₂, 12% 02, 2% H₂O, balanced with He) at 400° C., which will accumulate about 5 mg SO₂ per gram of catalyst. The NOx adsorption and absorption capacity of different catalysts before and after sulfation is measured at 100° C. following the procedures of example 1. The results are listed in Table 2.

### Example 4: NOx Adsorption and Absorption Capacity after Reduction Condition Testing Procedures

The catalyst (Na-MC) was subjected to reducing condition by heating it to 400° C. in 1% H₂ (balanced with He) with a ramping rate of 10° C./min, and then held at 400° C. for 30 min. The NOx adsorption and absorption capacity of the catalyst after reduction is measured at 100° C. for 3 times. The results are listed in Table 3.

TABLE 1
the NOx capacity (mg_{NOx}/g_{cat}) of different
catalysts at different temperatures.

| Catalyst | 25° C. | 100° C. | 200° C. | 300° C. |
|---|---|---|---|---|
| MC | 3.2 | 2.6 | — | — |
| MT | 3.0 | 2.7 | — | — |
| Na-MC | 5.4 | 5.7 | 6.3 | 4.8 |

TABLE 2
The NOx adsorption and absorption capacity (mg_{NOx}/g_{cat})
of different catalysts after sulfur exposure at 100° C.

| Catalyst | 100° C. |
|---|---|
| MC | 2.6 |
| Na-MC | 5.6 |

TABLE 3
NOx adsorption and absorption capacity
(mg_{NOx}/g_{cat}) at 100° C. of Na-MC after H₂ reduction.

| Catalyst | 1^{st} run | 2^{nd} run | 3^{rd} run |
|---|---|---|---|
| Na-MC | 6.1 | 5.5 | 5.6 |

A NOx sorbent material effectively absorbed and absorbed NOx emission at any temperature below 350° C. and release adsorbed and absorbed NOx at or above 350° C. The NOx sorbent material as hereinbefore described includes a manganese compound, a promoter, and a support. The Mn-based compound of the NOx sorbent material as hereinbefore described includes inorganic manganate oxides (such as manganese dioxide), inorganic/organic manganese compounds (such as manganese chloride and manganese acetate), or mixture thereof.

The promoters of the NOx sorbent material as hereinbefore described including compounds of group 1 elements, hydroxides, carbonates, bicarbonates, nitrates, nitrites of lithium, sodium, potassium, cesium and mixtures thereof.

The supports of the NOx sorbent material as hereinbefore described include normal supports with large surface area, which are preferably inorganic oxides including transition metal oxides (such as TiO₂), main-group metal oxides (such as MgO), rare earth metal oxides (such as CeO₂) and etc., zeolites, large surface area carbon-based materials or a mixture of any two or more thereof, e.g. ceria-zirconia or ceria-zirconia-alumina. The NOx sorbent material as hereinbefore described has a suitable oxygen partial pressure of 0 to 21%.

Although the present invention has been described in connection with preferred embodiments thereof, it will be appreciated by those skilled in the art that additions, deletions, modifications, and substitutions not specifically described may be made without departing from the spirit and scope of the invention as defined in the appended claims.

1. A Nitrogen Oxide (NOx) sorbent material comprising:
a manganese catalyst; and,
a support material;
wherein a composition of the manganese catalyst is configured to adsorb and absorb Nox at or below a set point temperature and to release the adsorbed and absorbed NOx at a second temperature above the set point temperature.

2. The material of claim 1, wherein the set point temperature is 350° C.

3. The material of claim 1 wherein the manganese catalyst comprises a promoter, an Mn-based compound, and other additives.

4. The material of claim 3 wherein the promoter is an alkali and/or alkaline earth metal compounds selected from Group IA and Group IIA, consisting hydroxides, carbonates, bicarbonates, nitrates, nitrites of lithium, sodium, potassium, cesium and mixtures thereof.

5. The material of claim 1 wherein the support material is one chosen from a group consisting of inorganic oxides including transition metal oxides (such as TiO₂), main-group metal oxides (such as MgO), rare earth metal oxides (such as CeO₂) and etc., zeolites, large surface area carbon-based materials or a mixture of any two or more thereof, e.g. ceria-zirconia or ceria-zirconia-alumina.

6. The material of claim 3 wherein the additives are chosen from platinum group metals and/or transition metal oxides.

7. The material of claim 1 wherein an applicable oxygen concentration ranges from 0 to 21%.

8. The material of claim 3 wherein the manganese catalyst further comprises 1% to 50% of promoter based on a total weight of the manganese catalyst.

9. A method of using the NOx sorbent material of claim 1 comprising adsorbing and absorbing NOx from exhaust gas generated by low temperature combustion (LTC) diesel or gasoline engine in various operating conditions.

10. A method of using the NOx sorbent material of claim 1 comprising using the NOx sorbent material during a full period following a cold start.

11. A method of using the NOx sorbent material of claim 1 comprising using the NOx sorbent material during a full period following a cold start through a warmed-up operation.

12. A method of using the NOx sorbent material of claim 1 comprising using the NOx sorbent material during an operation period of one chosen from a group consisting of a lean-burn gasoline engine, a clean diesel engine combustion engine (CDC), and a gas direct injection engine (GDI).

13. A NOx sorbent material comprising:
a multi-metallic oxide that includes one or more alkali or alkaline earth metal;
one or more 3d transition metal;
one or more rare earth element;
wherein a composition of the multi-metallic oxide, 3d transition metal, and one or more rare earth elements is configured to adsorb and absorb NOx below a set point temperature and to release the adsorbed or absorbed NOx at a second temperature at or above the set point temperature.

14. The material of claim 13, wherein the set point temperature is 350° C.

15. The material of claim 13 wherein the 3d transition metals further comprise an alkali and/or alkaline earth metal compound consisting of oxides, hydroxides, carbonates, bicarbonates, nitrates, nitrites of lithium, sodium, potassium, cesium and mixtures thereof.

16. The material of claim 13 wherein the one or more 3d transition metal is one chosen from platinum group metals and/or transition metal oxides.

17. A method of NOx sorption comprising:
applying an NOx sorbent material to exhaust gas, wherein the NOx sorbent material comprises:
a manganese catalyst; and,
a support material;
wherein a composition of the manganese catalyst is configured to adsorb and absorb NOx below a set point temperature and to release the adsorbed and absorbed NOx at second temperature at or above the set point temperature.

18. The method of claim 17 further comprising using the NOx sorbent material during a full period following a cold start.

19. The method of claim 17 further comprising using the NOx sorbent material during a full period following a cold start through a warmed-up operation.

20. The method of claim 17 further comprising using the NOx sorbent material during an operation period of one chosen from a group consisting of a lean-burn gasoline engine, a clean diesel engine combustion engine (CDC), and a gas direct injection engine (GDI).
